(19) United States
(12) Patent Application Publication
(10) Pub. No.: US 2005/0284199 A1
(43) Pub. Date: Dec. 29, 2005

(54) Latch assembly

(76) Inventors: Thomas Dean Gulley, Monrovia, CA (US); Frank E. Glover, Corona, CA (US)

Correspondence Address: Brian F. Drazich;COUDERT BROTHERS LLP, 23rd Floor, 333 South Hope Street, Los Angeles, CA, 90071-1406, US

(21) Appl. No.: 10/875,424

(22) Filed: Jun. 23, 2004

(51) Int. Cl. E05B 13/00

(52) U.S. Cl. 70/208

(57) ABSTRACT

The present invention provides a latch assembly of the type commonly used on commercial vehicles which is simple to manufacture and has few parts. The latch assembly secures a closure element, or striker, in either of two secure positions by means of independently operable dual linear latch bolts and may be closed when the locking mechanism is in a locked position, to facilitate ease of operation and to prevent damage to the latch. The latch bolts are releasable by operation of a remotely located handle actuated rotary latch mechanism.

### FIELD OF INVENTION

The present invention is directed to a latch assembly of the type commonly used on commercial vehicles, including tradesmen's specialized truck bodies, recreational vehicles, tool boxes, storage lockers and sheds, out buildings and the like. The present invention provides a latch assembly for retaining a striker element securely in either of two positions releasable by operation of a handle actuated rotary mechanism.

Conventional locks and latch assemblies of the kind commonly used in the above described applications have exhibited a number of problems and drawbacks which the present invention is intended to resolve or improve upon. These problems and drawbacks include the use of many parts and often complicated combinations of motions between the parts to provide open, closed and locked positions, thereby tending to increase the complexity and cost of the manufacturing process. Additionally, it is often not possible to close the latching mechanism when it is in the locked position. Furthermore, some conventional latch assemblies which provide two closure positions, one fully closed position and a second partially closed, or “safety”, position, may relatively easily be forced to a fully open position from the partially closed position.

### SUMMARY OF INVENTION

Latch assemblies of the type commonly used on commercial vehicles and the like are well known. Examples of such locks or latch assemblies include those described in U.S. Pat. Nos. 5,042,853, 5,299,844, 5,941,104 and 6,349,577.

It is an object of the present invention to provide a latch device which is simple to manufacture and which has few parts.

It is a further object of the present invention to provide a latch closure mechanism which may be closed when the latch locking mechanism is in a locked position, to facilitate ease of operation and to prevent potential damage to the latch.

It is a further object of the present invention to provide a latch closure with two releasable closure positions—a first partially closed position and a second fully closed position—both of which securely retain a closure striker and may not be forced to the open position.

It is a further object of the present invention to provide a releasable non-rotary latch closure mechanism with two independently operable linear closure bolts for sequential striker engagement.

It is a further object of the present invention to provide a latch assembly for retaining a striker element securely in either of two positions releasable by operation of a handle actuated rotary mechanism.

A general description of the latch assembly of the present invention directed to overcoming the aforementioned problems and drawbacks in a simple novel manner are as follows. A latch assembly for releasably securing a closure element, or striker, in either of two secure positions by means of independently operable dual linear latch bolts is provided. The invention contemplates that the linear latch bolts are releasable by operation of a remotely located handle actuated rotary latch mechanism. The invention also contemplates a locking cam movable relative to the rotary latch between locked and unlocked positions. In the locked position, the locking cam blocks rotation of the rotary latch mechanism to prevent release of the connected but remotely located linear latch bolts from a striker or closure element. As contemplated in this invention, the linear latch bolts may engage and secure a striker or closure element regardless of whether the locking cam is in the locked or unlocked position.

### BRIEF DESCRIPTION OF THE DRAWINGS

FIG. 1 is a front perspective view of the latch assembly rotary mechanism of the present invention.

FIG. 1A is a cross-sectional view of the FIG. 1 embodiment along line 1A-1A.

FIG. 2 is a back view of the FIG. 1 embodiment in the open position.

FIG. 3 is a cross-sectional view of the FIG. 1 embodiment along line 3-3.

FIG. 4 is a back view of the FIG. 1 embodiment in the unlocked position.

FIG. 4A is a cross-sectional view of the FIG. 4 embodiment along line 4A-4A.

FIG. 5 is a back view of the FIG. 1 embodiment in the locked position.

FIG. 6 is a front perspective view of the dual bolt latch of the present invention.

FIG. 7 is a cross-sectional view of the dual bolt latch of the present invention along a longitudinal plane of symmetry.

FIG. 8A is a front perspective view of the smaller body portion of the dual bolt latch of the present invention.

FIG. 8B is a front perspective view of the larger body portion of the dual bolt latch of the present invention.

FIG. 9 is a front view of the dual bolt latch of the present invention.

FIG. 10 is a side perspective view of the body of dual bolt latch of the present invention disassembled.

FIG. 11 is a side perspective view of the internal mechanism of dual bolt latch of the present invention disassembled.

FIG. 12 is a side perspective view of the internal mechanism of dual bolt latch of the present invention assembled.

FIG. 13 is a cutaway view of the dual bolt latch of the present invention.

FIG. 14A is a front view of the body of an alternative embodiment of the dual bolt latch of the present invention.

FIG. 14B is a rear view of the body of an alternative embodiment of the dual bolt latch of the present invention.

FIG. 14C is a transverse cross-sectional view of the FIG. 14A embodiment.

FIG. 15A is a side cross-sectional view of the operator shaft of an alternative embodiment of the dual bolt latch of the present invention.

FIG. 15B is a top cross-sectional view of the operator shaft of an alternative embodiment of the dual bolt latch of the present invention.

FIG. 15C is a side cross-sectional view of the operator shaft of an alternative embodiment of the dual bolt latch of the present invention.

FIG. 15D is a top cross-sectional view of the operator shaft of an alternative embodiment of the dual bolt latch of the present invention.

FIG. 15E is a transverse cross-sectional view of the operator shaft of an alternative embodiment of the dual bolt latch of the present invention.

FIG. 15F is a transverse cross-sectional view of the operator shaft of an alternative embodiment of the dual bolt latch of the present invention.

FIG. 16A is a cross-sectional view of an alternative embodiment of the dual bolt latch of the present invention along a longitudinal plane of symmetry.

FIG. 16B is a cross-sectional view of an alternative embodiment of the dual bolt latch of the present invention along a longitudinal plane of symmetry.

FIG. 16C is a cross-sectional view of an alternative embodiment of the dual bolt latch of the present invention along a longitudinal plane of symmetry.

### DETAILED DESCRIPTION OF PREFERRED EMBODIMENTS

Preferred Embodiments of the Latch Assembly Rotary Mechanism

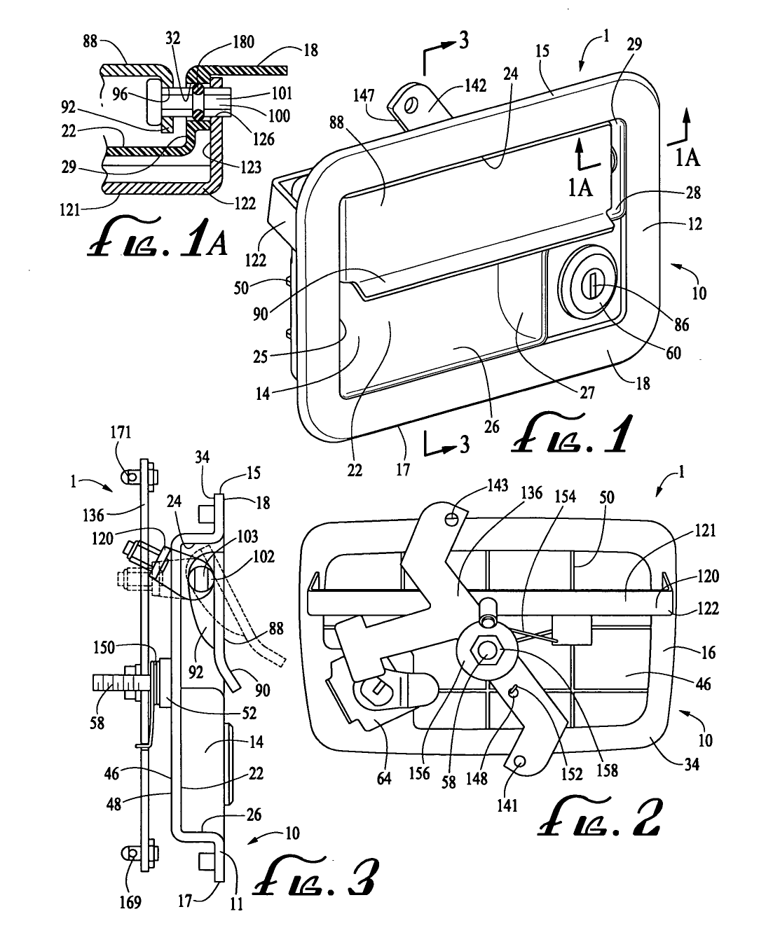

With reference to FIGS. 1, 1A, 2, 3, 4, 4A and 5, a latch assembly rotary mechanism (1) including a housing (10) formed of an essentially rigid impact resistant and corrosion resistant material such as a polymer or metal, and having a housing wall (11) which may vary in thickness from on the order of about 2 mm to on the order of about 8 mm. It is preferred that the housing be made of high impact polymeric material, metal or other material having the necessary rigidity and strength. The housing (10) includes a front side (12), in which a cavity (14) is formed, and a back side (16), as well as a top edge (15) and a bottom edge (17). Front side (12) includes substantially flat front surface (18) and lock mechanism mounting opening (20) (not shown) which penetrates the housing (10). Also, included in front side (12) of housing (10) is cavity floor (22) and cavity walls (24), (25), (26), (27), (28) and (29) joining with and surrounding cavity floor (22) and joining cavity floor (22) with substantially flat front surface (18) which forms a rim or lip extending peripherally outward around cavity (14). A first handle axle mounting hole (30) (not shown) is formed through and penetrates cavity wall (25). A second handle axle mounting hole (32) is formed through and penetrates cavity wall (29).

With reference to FIGS. 2, 3, 4 and 5, back side (16) of housing (10) includes substantially flat rear surface (34) which is disposed on the opposite surface of housing wall (11) from substantially flat front surface (18). The cavity (14) formed in the front side (12) of housing (10) of course results in a corresponding protrusion (46) in the back side (16) of the housing (10). Protrusion (46) includes top surface (48) which is the surface opposite cavity floor (22) and side surfaces, unnumbered, which are the back surfaces of cavity walls (24), (25), (26), (27), (28) and (29), respectively, through housing wall (11). Protrusion (46) also includes ribs (50) and hardware mounting blocks (52) and (54) positioned at predetermined locations. Threaded stud (58), preferably made of steel, is fixedly attached to mounting block (52) and projects outwardly orthogonal to the plane of top surface (48).

With further reference to FIGS. 2, 3, 4 and 5, lock mechanism (60) is mounted in opening (20) (not shown). Lock mechanism (60) is retained in place by spring clip (64) which bears on rear surface (34), or by other conventional means. Locking cam (70) is fixedly retained on shaft (72) by conventional means such as by a retaining spring clip, such that locking cam (70) rotates when shaft (72) is rotated. Locking cam (70) includes cam engaging pad (82). The lock cylinder shaft (72) and locking cam (70) are rotated from a first locked position to a second unlocked position by manual rotation of a key matched to the tumblers of lock mechanism (60), inserted into key slot (86).

With reference to FIGS. 1, 1A and 3, handle plate (88) preferably formed of corrosion resistant sheet steel includes grasp portion (90) together with a first mounting bracket (92) at a first end and an essentially symmetrical second mounting bracket (94) (not shown) at an opposite second end. The mounting brackets (92) and (94) (not shown) are formed by bending the first end and the second end of plate (88) at approximately right angles to the plane of the handle plate (88). The end plates (92) and (94) may be made from the plate which forms the handle plate (88) or joined to it by any conventional means. Mounting bracket (92) of handle plate (88) includes keyed axle hole (96), and mounting bracket (94) (not shown) includes axle hole (98) (not shown) which may be keyed or unkeyed. Axles (100) and (102) are preferably formed of corrosion resistant steel. Axle (100) includes a keyed shaft (101) and axle (102) includes a shaft (103) which may be either keyed or unkeyed. Keyed axle (100) extends through axle hole (96) in mounting bracket (92), and through axle mounting hole (32) in housing wall (29), and thence through axle mounting hole (128) (not shown) in actuator bar (120). Similarly to as just described with respect to axle (100), coaxially positioned keyed or unkeyed axle (102) extends through axle hole (98) in mounting bracket (94) (not shown), and through axle mounting hole (30) in housing wall (25), and thence through axle mounting hole (126) in actuator bar (120). Keyed shaft (101) of axle (100), keyed axle hole (96) in mounting bracket (92), and axle mounting hole (128) (not shown) in actuator bar (120) are adapted to fit together in a complementary fashion such that when handle plate (88) is moved or displaced, axles (100) and (102) are caused to rotate and to pivot within mounting holes (30) and (32) of housing (10), and thus to pivot actuator bar (120) about the common axis of rotation of the axles, which are retained in position by conventional means such as by flaring, pinning, snap ring or other conventional means.

With additional reference to FIGS. 1, 1A, 2, 3, 4, 4A and 5, handle plate (88) is operated by application of an outward or pulling force on grasp portion (90) which causes grasp portion (90) to move away from cavity floor (22) thereby rotating the handle plate (88) and the axle (100), (102) subassemblies. Upon release of the outward or pulling force on grasp portion (90), the action of coil spring (0.150) returns the handle plate (88) to its initial rest position within cavity (14). Actuator bar (120), preferably made of steel, extends across the back side (16) of housing (10) and is affixed at its ends to axles (100) and (102) on the back side (16) of housing (10). Actuator bar (120) includes a first end (122) having axle mounting hole (126) and a second end (124) having axle mounting hole (128) (not shown). Actuator bar (120) axle mounting holes (126) and (128) (not shown) are adapted to receive axle shafts (101) and (103), respectively. The actuator bar (120) is fixedly attached to axles (100) and (102) by conventional means such as flaring, pinning, snap ring and groove, press fit, welding, screw, rivet or other means to provide a fixed connection.

With further reference to FIGS. 1, 1A, 2, 3, 4, 4A and 5, approximately, mid-way along the span of actuator bar (120) is fixedly mounted roller bearing shaft (130) which projects substantially orthogonally from the rear surface (121) of bar (120). Bearing shaft (130) is fixedly connected to actuator bar (120) by conventional means such as press fit, welding, snap ring and groove, screw, rivet or other means to provide a fixed connection. Rotatingly retained on bearing shaft (130) by conventional means such as a screw, is roller bearing (132). Roller bearing (132) is preferably made of steel or other material suitable for use as a bearing.

With reference to FIGS. 2, 3, 4 and 5, actuator plate (136) is a substantially planar plate, rotatably retained on threaded stud (58) by a nut (158), or other conventional means. Actuator plate (136) includes a central section (138) and three distal portions or arms (140), (142) and (144) extending outwardly or away from central section (138). The central section (138) of actuator plate (136) includes plate mounting hole (146) (not shown) and a spring retention adaptation such as hole (148). Plate mounting hole (146) (not shown) is sized to closely but slidingly admit threaded stud (58) and to permit plate (136) to rotate freely about stud (58) without binding. Disposed on stud (58) between top surface (48) and actuator plate (136) is a spacer (137) (not shown) having a diameter sized to loosely fit within the inner diameter of a coil spring (150). Spacer (137) (not shown) is preferably made of a resilient polymeric or other material having a low coefficient of sliding friction. Also, disposed on stud (58) between top surface (48) and plate (136) is coil spring (150). The height or thickness of spacer (137) (not shown) is selected to permit coil spring (150) to flex freely and without binding on either top surface (48) or actuator plate (136). Extending from coil spring (150) is first spring arm (152) and second spring arm (154), the distal ends of each of which are adapted or shaped to engage spring arm anchor points. The distal end of coil spring first arm (152) movably engages and is retained in a spring retention adaptation such as hole (148) of plate (136). Coil spring second arm (154) is anchored to top surface (48) such as by engaging a rib (50) at its distal end. Coil spring (150) is tensioned to apply a restoring force to actuator plate (136), and thus to handle (88), when plate (136) is rotated about stud (58) by movement of actuator bar (120) in response to lifting handle (88). Actuator plate (136) is retained on threaded stud (58) by conventional means such as by washer (156) and lock nut (158).

With further reference to FIGS. 2, 3, 4 and 5, actuator plate first distal portion or arm (140) extends away from the central portion (138) substantially in the direction of the bottom edge (17) of the housing (10). Arm (140) includes a connecting rod bracket mounting hole (141) adapted to movably retain a connecting rod bracket (169). Actuator plate second distal portion or arm (142) extends away from the central portion (138) substantially in the direction of the top edge (15) of the housing (10). Actuator plate second arm (142) includes a connecting rod bracket mounting hole (143) adapted to movably retain a connecting rod bracket (171). The second arm (142) of the actuator plate (136) is disposed such that first edge (145) of arm (142) forms an engaging surface (147) which bears upon roller bearing (132). The first edge (145) of arm (142) between the central portion (138) of actuator plate (136) and mounting hole (146) (not shown) is configured to have two substantially straight branches which meet at an angle (149) to form an “L” or “V” shape. Actuator plate (136) is disposed such that when handle plate (88) is in it's at rest position within cavity (14), roller bearing (132) rests in the apex of the angle (149).

With additional reference to FIGS. 2, 3, 4 and 5, actuator plate third arm (144) extends outwardly from second arm (142) toward the region located between the actuator bar (120) and lock mechanism (60). Third arm (144) includes end plate (162) having tabs (164) and (166) formed on its lower and upper edges, respectively. It will be understood by one of ordinary skill in the art that actuator bar (120) and actuator plate (136) need not have the particular configurations and shapes described herein, but that other configurations and shapes of the actuator bar (120) and/or actuator plate (136) which function as described herein are within the scope of the present invention.

In another preferred embodiment of the present invention, the axle shafts (101) and (103) are adapted to receive a resilient seal or an O-ring (180). Also, the surface of the back side (16) of housing (10) immediately adjacent to and surrounding mounting holes (30) (not shown) and (32) is adapted to receive the seal or O-ring (180). A seal or O-ring (180) is slidingly and sealingly disposed on each axle shaft (101) and (103), and is positioned and retained in sliding and sealing contact with the surface of back side (16) and the front surface (123) of actuator bar (120). Thus, the seal or O-ring (180) forms a weather resistant barrier to entry of moisture and debris into the latch mechanism and the area behind the housing (10).

The operation of the latch assembly mechanism of the present invention is described as follows.

The Closed and Locked Position of the Latch Assembly Rotary Mechanism

With reference to FIG. 5, the latch is locked in the closed position by rotating the lock mechanism (60) to a first locked position by means of key inserted into key slot (86). When lock mechanism (60) is in the first locked position, engaging pad (82) of locking cam (70) is juxtaposed closely adjacent to tab (164) of third arm (144) of actuator plate (136). Also, engaging pad (82) is then disposed in the path of movement of arm (144), upon rotation of plate (136) about stud (58). Thus, rotation of actuator plate (136) is prevented by blocking or interference of tab (164) by engaging pad (82). In the locked position, roller bearing (132) of actuator bar (120) is restrained and confined to the apex of angle (149) of the immobilized second arm (142) of actuator plate (136), thus preventing motion of actuator bar (120) and the connected handle plate (88). Accordingly, in the closed and locked position, handle plate (88) is not free to move or rotate, but is held in a stationary closed position.

The Closed and Unlocked Position of the Latch Assembly Rotary Mechanism

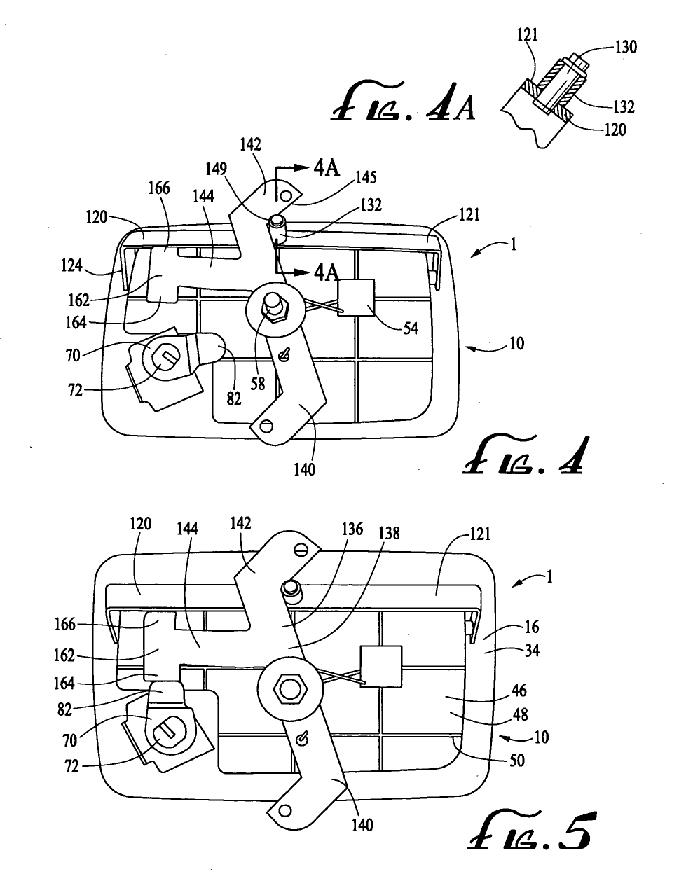

With reference to FIG. 4, the latch is unlocked in the closed position by rotating the lock mechanism (60) to a second unlocked position by means of a key inserted into key slot (86). When lock mechanism (60) is in the second position, engaging pad (82) of locking cam (70) is positioned away from tab (164) of actuator plate third arm (144). Also, engaging pad (82) is then removed from the path of movement of arm (144), upon rotation of plate (136) about stud (58). Thus, rotation of actuator plate (136) is permitted. The actuator plate (136), actuator bar (120) and handle (88) remain in the closed at rest configuration, with roller bearing (132) resting in the apex of angle (149), by the action of coil spring (150).

The Open Position of the Latch Assembly Rotary Mechanism

With reference to FIGS. 2 and 3, the latch is opened from the unlocked position by pulling handle plate (88) outward or away from cavity floor (22) thus causing handle plate (88) to rotate axles (100) and (102) against the restoring force of coil spring (150). The rotation of axles (100) and (102) about their common axis of rotation in turn causes the affixed actuator bar (120) to pivot thereby moving attached roller bearing (132) in a direction toward stud (58). The movement of roller bearing (132) toward stud (58) causes bearing (132) to roll against first edge (145) of second plate arm (142). Because the motion of bearing (132) is confined to a plane substantially perpendicular to the plane of the actuator plate (136), while actuator plate (136) is free to rotate about stud (58), movement of bearing (132) against edge (145) of arm (142) toward stud (58) causes actuator plate (136) to rotate about stud (58). The rotation of plate (136) in turn causes connecting rod bracket mounting holes (141), (143) and the movably affixed connecting rod brackets (169), (171) to transcribe an arc, the chord of which represents the translation component of the movement of the ends of connecting rods (168) (not shown) and (170) (not shown) movably attached thereto. The movement of the connecting rods (168) (not shown) and (170) (not shown) causes the engaged distal ends of the connecting rods to disengage a latching closure device such as the dual bolt latch described below.

With reference to FIG. 4, when the roller bearing (132) is positioned along edge (145) of arm (142) between the apex of angle (149) (not shown) and washer (156), the end plate (162) of third arm (144) blocks the rotational path of locking cam (70) thereby preventing the pocket latch mechanism (1) from being locked in the open position.

Preferred Embodiments of the Dual Bolt Latch

A preferred embodiment of dual bolt latch (200) includes two body portions (210a) and (210b) formed of an essentially rigid impact resistant and corrosion resistant material such as metal, composite or polymer. The body portions (210a) and (210b) are mated and joined together by mechanical fasteners, bonding or other conventional means to form a unit which includes the operating mechanism of the latch. In a preferred embodiment, the latch (200) has the shape substantially of a rectangular solid with projections or tabs for mounting the assembly.

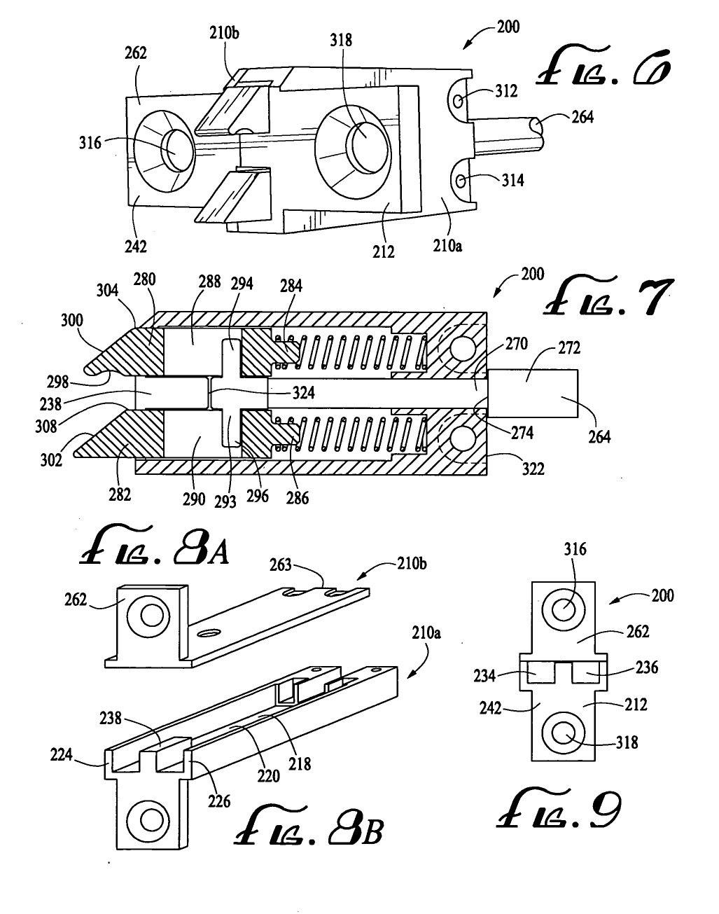

With reference to FIGS. 6, 8B, 9 and 10, first body portion (210a) includes a first end (212) and a body rear surface (322) together with a substantially planar first surface (216) having a cavity (218). Substantially “U” shaped cavity (218) is formed in first surface (216) of body portion (210a). Cavity (218) has a substantially planar floor (220) which is essentially parallel with the plane of first surface (216). Cavity floor (220) is surrounded on three sides by rear wall (222) and side walls (224) and (226), which extend perpendicularly from floor (220) to first surface (216). A straight central channel (228) having a substantially “U” shaped cross-section is formed in first surface (216) and extends between and communicates with body rear surface (322) and rear wall (222) to provide a passage from cavity (218) through channel (228) to the exterior of body portion (210a). Disposed in surface (216) adjacent to and on either side of central channel (228) and communicating with cavity (218) are formed smaller cavities or spring pockets (230) and (232). Similarly, as shown in FIGS. 8A, 9 and 10, second body portion (210b) includes a first end (262) and second end surface (263) together with a substantially planar first surface (260).

With further reference to FIGS. 7, 8B, 10 and 13, first body portion (210a) includes latch bolt channel separator (238) having planar first surface (240). Disposed essentially perpendicular to surface (240) of separator (238) is assembly hole (248) which penetrates from surface (240) through body (210a). Channel separator (238) is disposed in alignment with central channel (228), as shown, to form first latch bolt channel (234) and second latch bolt channel (236), each latch bolt channel preferably having a substantially “U” shaped cross-section. Channel separator planar surface (240) is preferably disposed between the planes of cavity floor (220) and body first surface (216). Disposed in body first surface (216) adjacent to and on either side of central channel (228) and formed essentially perpendicular to surface (216) are assembly holes (244) and (246) which penetrate from surface (216) through body (210a).

With continued reference to FIG. 10, second body portion (210b) includes planar surface (260), as mentioned. Disposed on and extending above surface (260) is latch bolt channel separator (256) having planar surface (258) and assembly hole (254). Assembly hole (254) extends essentially perpendicularly from surface (258) through second body portion (210b). The planar surfaces (240) and (258) have essentially the same shape and are adapted to touchingly interface when first body portion (210a) and second body portion (210b) are assembled with surfaces (216) and (260) in contact. Similarly, assembly holes (244), (246) and (248) of first body portion (210a) are aligned with assembly holes (250), (252) and (254), respectively, of second body portion (210b) when first body portion (210a) and second body portion (210b) are assembled with surfaces (216) and (260) in full contact. The first end (212) of first body portion (210a) and the first end (262) of second body portion (210b) are each adapted to provide mounting plates for attachment of the assembled dual bolt latch (200) to a door, lid, gate, hatch or other closure device, as shown in FIGS. 6, 8A, 8B and 9. In this regard, end portions (212) and (262) contain mounting latch mounting holes (316) and (318), respectively.

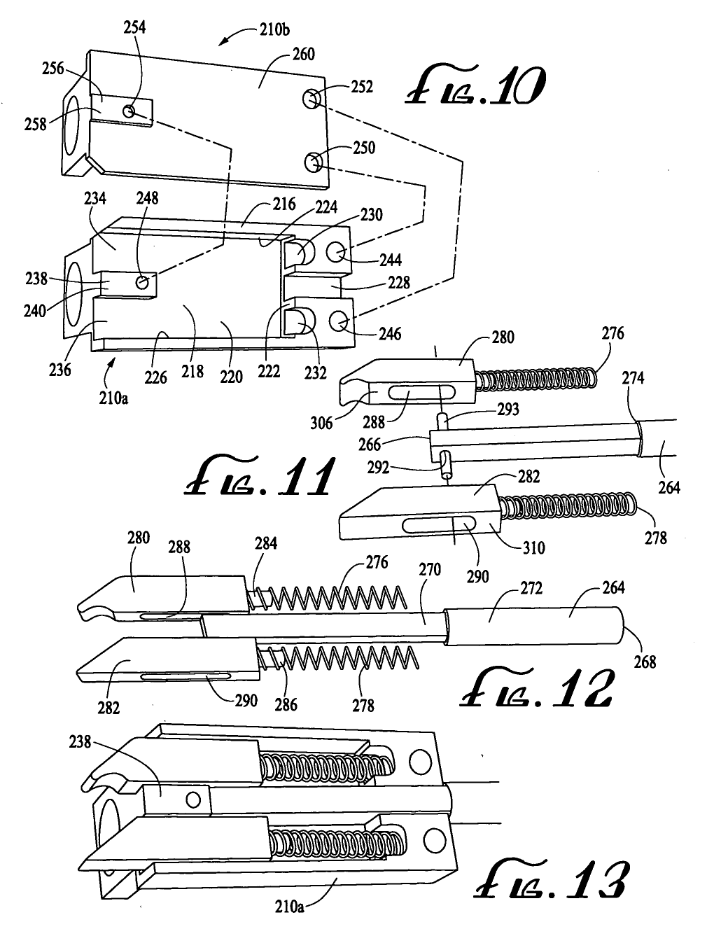

With respect to FIGS. 7, 11, 12 and 13, partially assembled views of the internal latching mechanism are depicted. First latch bolt (280) and second latch bolt (282) having arbitrarily designated top surfaces (304) and (308), and opposite bottom surfaces (306) and (310), respectively. First latch bolt (280) includes elongated slot (288) which extends in the direction of the greatest dimension of bolt (280). Slot (288) extends perpendicularly from bottom surface (306) of bolt (280) partially or entirely through bolt (280). Similarly, second latch bolt (282) includes elongated slot (290) which extends in the direction of the greatest dimension of bolt (282). Slot (290) extends perpendicularly from top surface (308) of bolt (282) partially or entirely through bolt (282). Latch bolts (280) and (282), respectively, include spring retention pegs (284) and (286), as shown, adapted to retain coil springs (276) and (278), respectively, preferably by friction fit. First latch bolt (280) at its end opposite spring retention peg (284) includes flat angled surface (300) which extends between top surface (304) and bottom surface (306), to provide a first striker contact surface. First latch bolt (280) also includes in its bottom surface (306) groove (298) which is disposed perpendicular to the greatest dimension of bolt (280), and proximate the bolt end opposite spring retention peg (284). Similarly, second latch bolt (282) at its end opposite spring retention peg (286) includes flat angled surface (302) which extends between top surface (308) and bottom surface (310), to provide a second striker contact surface.

With further reference to FIGS. 7, 11, 12 and 13, said latching mechanism includes operator shaft (264) having an internal portion (270) and an external portion (272). In a preferred embodiment, internal portion (270) has a square or rectangular cross-section and external portion (272) has a round or oval cross-section. Naturally, one of ordinary skill in the art will recognize that operator shaft (264) will function with a variety of cross-sections. It is preferred that external portion (272) of shaft (264) have a greater cross-sectional area than internal portion (270), to provide a flat flange or ledge (274) at the junction of the said internal and external portions of shaft (264). The length, or greatest dimension, of internal portion (270) of shaft (264) is essentially equal to the distance between the rear surface (322) of body (210a) and the rear surface (324) of channel separator (238). Contact between body rear surface (322) and shaft ledge (274) and/or between rear surface (324) of channel separator (238) and first end (266) of shaft (264) limits the travel of shaft (264) in the direction from central channel (228) toward separator (238). Second end (268) of shaft (264) is adapted to connect with an operating element such as a rod, cable or other linking device to a remote operating mechanism such as the above described pocket latch.

Located proximate the first end (266) of shaft (264) is bore (292) which extends through shaft (264) perpendicular to the greatest dimension of shaft (264). Retained in bore (292) by friction fit or other conventional means is an engaging pin (293) having first end (294) and second end (296). First end (294) of engaging pin (293) is adapted to engage and travel in elongated slot (288) of first bolt (280), and the second end (296) of pin (293) is adapted to engage and travel in elongated slot (290) of second bolt (282).

The free ends of coil springs (276) and (278) opposite the attachment with pegs (284) and (286), respectively, are disposed in spring pockets (230) and (232), respectively, which together with surface (260) of second body portion (210b) form cups in which said free ends of springs (276) and (278) are retained when body portions (210a) and (210b) are assembled together, as suggested in FIGS. 8A, 8B, 10 and 13.

The latch (200) may be assembled by installing the latch bolts (280) and (282), coil springs (276) and (278), and operator shaft (264), shown in FIGS. 7, 11, 12 and 13, into first body portion (210a) as shown in FIGS. 7 and 13. Second body portion (210b) is then mated to first body portion (210a) such that planar surfaces (260) and (216) are in contact and juxtaposed with assembly holes (244), (246) and (248) of first body portion (210a) aligned with assembly holes (250), (252) and (254), respectively, as shown in FIG. 10. Then, rivets, screws, bolts or other conventional mechanical fasteners are installed through aligned pairs of assembly holes (244), (250), and (246), (252), and (248), (254). As shown for example FIG. 6 depicts rivets (312), (314) disposed in assembly holes (244), (250), and (246), (252), respectively, to fixedly attach body portions (210a) and (210b). When assembled, the portions of latch bolts (280) and (282) containing the flat angled surfaces (300) and (302), respectively, project beyond end surfaces (242) and (262) of body portions (210a) and (210b).

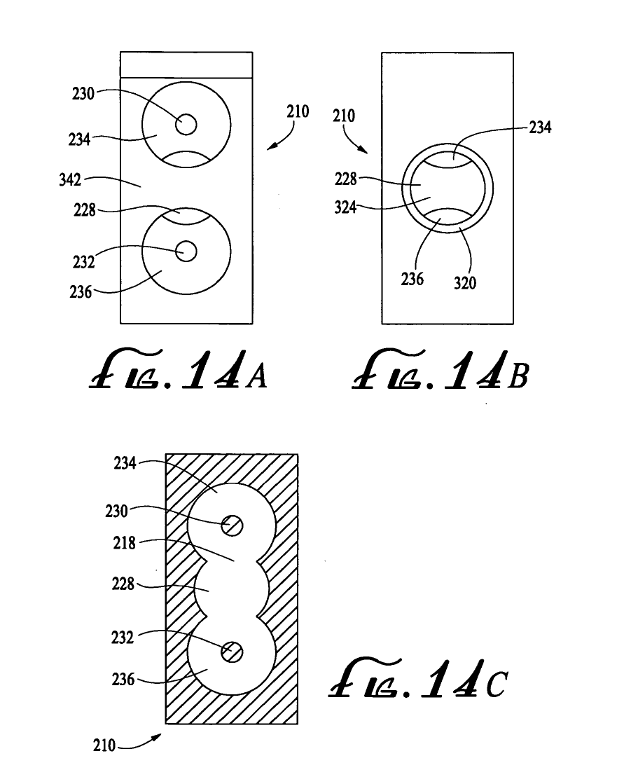

In another preferred embodiment, the body of the latch assembly (200) is formed as a single unit (210) rather than as first and second body portions (210a) and (210b). As shown in FIGS. 14A-14C, the single body unit (210) may be machined or milled from a resilient material such as metal or a tough polymer, or may be cast or molded from metal, polymer or other material having the necessary rigidity and strength. In this preferred embodiment, latch bolt channels (234) and (236) and spring pockets (230) and (232) may be formed when body unit (210) is molded or cast, or may be formed by boring, or a combination thereof. Similarly, central channel (228) and that portion of cavity (218) provided to accommodate operator shaft (264) may also be formed by molding, casting, boring or a combination thereof, or other conventional means as will be obvious to one of ordinary skill in the art.

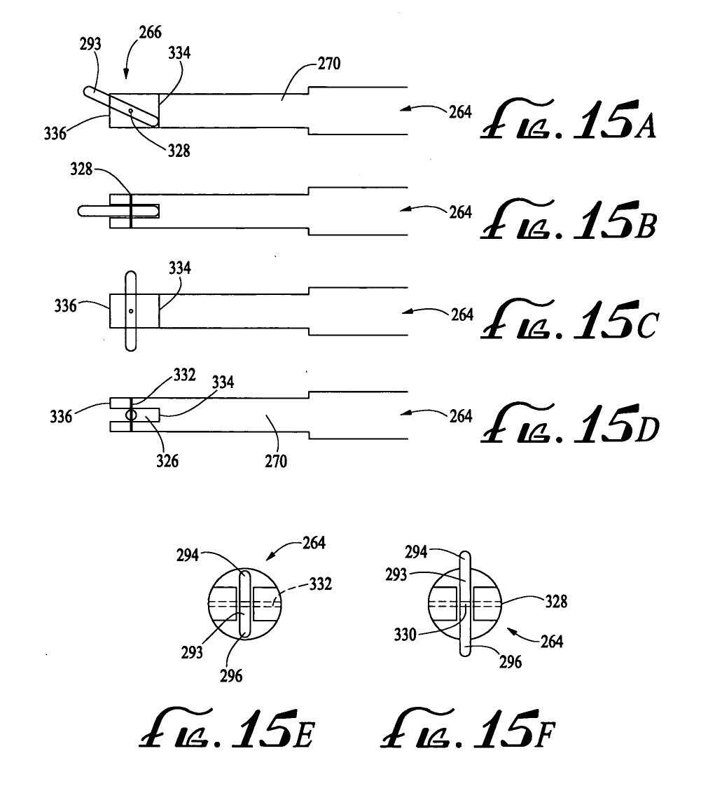

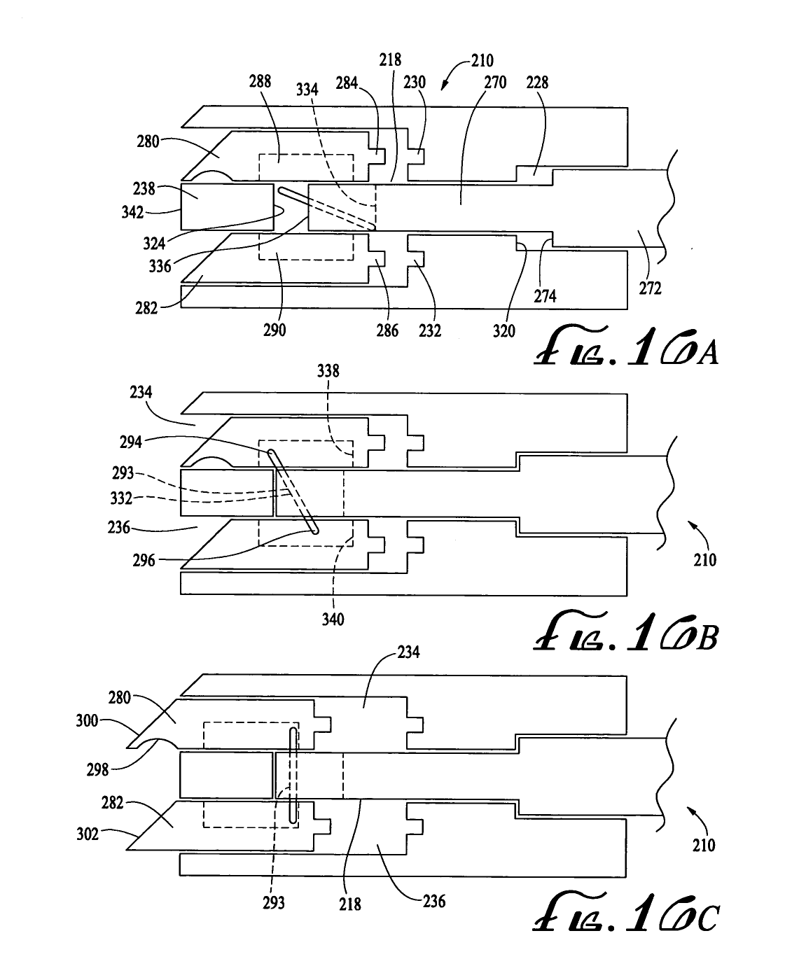

When the latch body (210) is fabricated as a single unit, engaging pin (293) is attached to operator shaft (264) as is described below. With reference to FIGS. 15A-15F, first end (266) of operator shaft (264) includes shaft slot (326) which is open on three sides. Proximate to end (266) and perpendicular to shaft slot (326) is pin axle hole (328) which extends through shaft (264). Engaging pin (293) includes axle hole (330) oriented perpendicular to the greatest dimension of pin (293) and which penetrates pin (293). Pin axle hole (328) of shaft (264) has a greater diameter than does axle hole (330) of pin (293). Pin axle (332) is adapted to fit tightly and nonrotatingly in axle hole (330) of pin (293), however, axle (332) is adapted to fit snugly but rotatingly in pin axle hole (328) of shaft (264). As described, pin axle (332) provides for rotation of pin (293) within shaft slot (326). Axle hole (330) of pin (293) is preferably located about midway between the two ends (294) and (296) of pin (293). The distance between the center of axle hole (330) of pin (293) and the ends (294) and (296) of pin (293) is selected to be greater than the distance between the center of pin axle hole (328) of shaft (264) and the end (334) of shaft slot (326).

The configuration just described prevents pin (293) from being aligned with its greatest dimension in parallel with the greatest dimension of shaft (264), as one end or the other of pin (293) will contact the end (334) of slot (326) and stop rotation of pin (293) while an angle remains between the greatest dimension of pin (293) and the greatest dimension of shaft (264). However, the length or greatest dimension of pin (293) as well as the distance between pin axle hole (328) of shaft (264) and the end (334) of shaft slot (326) are selected to allow pin (293) to rotate so that pin (293) is contained entirely within the cross-section of the internal portion (270) of shaft (264) when viewed along the direction of the length or greatest dimension of shaft (264). In such a configuration as just described, the internal portion (270) of shaft (264) with pin (293) attached may be inserted through central channel (228) into cavity (218).

Consistent with the foregoing, the distance between the end surface (336) of the first end (266) of operator shaft (264) and the center of pin axle hole (328) is selected to be substantially less than one-half the length, or greatest dimension, of pin (293) such that one end or the other of pin (293) extends beyond the end surface (336) of shaft (264) when pin (293) is rotated so that it is contained entirely within the cross-section of internal portion (270) of shaft (264), as discussed above, and as shown in FIGS. 15A, 15E and 16A.

The latch (200) having single unit body (210) is assembled as shown in FIGS. 16A-16C. First, the coil springs (276) and (278) are attached to the latch bolts (280) and (282). Next, the preassembled latch bolts and springs are inserted into body portion (210) through latch bolt channels (234) and (236), until springs (276), (278) engage spring pockets (230), (232). Then, latch bolts (280), (282) are further urged into channels (234), (236) until the bolts (280), (282) are flush with the face (342) of body (210) thereby compressing coil springs (276), (278). Next, the internal portion (270) of shaft (264) with pin (293) attached is inserted through central channel (228) into cavity (218), as shown in FIGS. 16A and 16B, until pin (293) first and then end surface (336) of shaft (264) sequentially contact the rear surface (324) of channel separator (238) thereby causing the pin (293) to rotate and the ends (294) and (296) of pin (293) each to enter one of the elongated cavities (288) and (290) of the latch bolts (280) and (282). Then, bolts (280), (282) are allowed to move in response to the restoring forces of springs (276), (278) until one of the ends (294), (296) of pin (293) contacts one of the rear walls (338), (340) of one of the elongated cavities (288), (290), thereby causing pin (293) to rotate to a position perpendicular to the length, or greatest dimension, of shaft (264), as shown in FIG. 16C. Thus, the operational configuration of dual bolt latch (200) having a single unit body (210) is achieved. Optionally, a stop, keeper pin or detent may be provided to maintain pin (293) in said perpendicular position within slot (326). It will be clear to one of ordinary skill in the art that the latch bolts (280), (282) and the latch bolt channels (234), 236), as well as the operator shaft (264) and central channel (228), may have any complementary cross-section. In an additional preferred embodiment of the single unit latch body (210) the cross-section of the latch bolts, latch bolt channels and central channel are circular or round.

With reference to FIGS. 14A and 14B, is shown front and back views, respectively, of single unit body (210) before the installation of other components. A transverse cross-section through cavity (218) of body (210) is shown in FIG. 14C, which shows how cavity (218) may be formed by bores made from opposite ends of the single piece body (210).

Operation of the Dual Bolt Latch

The operation of the dual bolt latch is the same for each preferred embodiment and is independent of the selected cross-section of the latch bolts or operator shaft. The two latch bolts (280), (282) of an assembled latch unit are free to move independently of one another in response to a motive force applied at the sloping or angled face (300), (302) of the bolt having a component parallel with the longest dimension of the bolt and in a direction toward the bolt end having the spring retention peg. The range of travel of the bolt is predetermined by the length of the elongated bolt slot (288), (290) in which the engaging pin (293) of the operator shaft (264) is disposed and by the characteristics of the coil spring (276), (278) engaging the bolt (280), (282). These parameters are preselected to allow each bolt to be displaced to a position contained entirely within the latch body (210).

As described above, when the assembled latch unit is at rest (i.e.—lowest possible potential energy state of the coil springs), the bolts (280), (282) are restrained from travel by interference between the engaging pin (293) and the rear wall of each bolt slot (288), (290), and the operator shaft (264) is constrained from further motion toward the latch bolts by interfering contact between the bolt channel separator (238) and the interior end of the shaft (264) as well as by interfering contact between the shaft flange (274) and the body ledge (320) or the body rear surface (322). Upon movement of the operator shaft (264) away from the bolt channel separator (238) and along the central channel (228), the engaging pin (293) acting against the rear wall of each bolt slot (288), (290) moves both bolts (280), (282), in their respective channels, toward the spring retaining pockets (230), (232) to retract the bolts into the latch body (210).

In use, the latch is typically installed on a hinged panel or door with the latch body substantially flush with the edge of the panel and the bolts extending beyond the edge of the panel. Correspondingly, a striker is typically installed on a frame adjacent to or surrounding the panel. The latch is oriented so that as the panel is closed into the frame, or when the frame and panel are brought substantially into the same plane, the striker first contacts the angled surface (300) of the first bolt (280) at an angle substantially orthogonal to the longest dimension, or length, of the bolt. As the panel continues to be closed, the striker causes the first bolt (280) to be moved along the bolt channel (234) into the latch body (210). Meanwhile, the second bolt (282) remains in its extended or at rest position as described above. Once the striker moves passed or beyond the first bolt (280) and is no longer in contact with its angled surface (300), the restoring force of the coil spring (276) quickly returns the first bolt (280) to its previous at rest position extending beyond the latch body (210). At this point, the striker is located in the region between the two extended latch bolts (280) and (282).

If at this point the motion of the panel is arrested, if for example because insufficient kinetic energy to completely close the panel had been imparted to it, the striker will be captured or retained in the region between the two latch bolts (280) and (282) thereby preventing the panel or door from reopening. To aid in preventing the panel or door from reopening in such a circumstance, the surface of the first bolt (280) then proximate the striker is not angled, but is parallel, with respect to the length of the bolt, and further contains a groove (298) oriented parallel with the striker. The non-angled surface and the groove (298) each act to facilitate retention of the striker between the first bolt (280) and second bolt (282), and to prevent the first bolt from retracting into the body in response to contact with the striker. Thus, the first bolt (280) acts to keep the panel or door from re-opening even if the door or panel is not completely closed.

If sufficient force or kinetic energy is imparted to the door or panel to completely close it, the striker moves on to contact the angled surface (302) of the second latch bolt (282) which is thus caused to move into the latch body (210) in the same manner as previously described for the first bolt. Similarly, when the striker moves passed or beyond the second bolt (282), the second bolt is returned to its extended or at rest position by action of the coil spring (278). Once the second bolt (282) has returned to its initial at rest position, the non-angled surface of the second bolt then proximate the striker acts to retain the striker and to prevent the second bolt (282) from retracting into the body (210) in response to contact with the striker. Thus, the striker is positioned between the second bolt (282) and the rim, lip, plate or other conventional latch covering element of the door or panel and the door or panel is held in a fully closed position until the latch is released.

The striker is released from the latch and the door or panel is thus allowed to open by retraction of both latch bolts (280), (282) into the latch body (210). Retraction of both latch bolts essentially simultaneously is accomplished by outward movement of the operator shaft (264) in response to pulling on the operator shaft. Upon movement of the operator shaft (264) in a direction away from the bolt channel separator (238), the engaging pin (293) of the operator shaft (264) in contact with the rear walls of the bolt slots (288), (290) acts against the coil springs (276), (278) to pull the bolts (280), (282) in the same direction along the bolt channels (234), (236) until the bolts are each retracted into the latch body (210) and the striker is thereby released. The operator shaft (264) is motivated by interconnection to the operative movable handle (88) of a latch assembly rotary mechanism (1) such as described above, or other conventional latch mechanism, via a connector element or elements such as connector rods (168), (170), push-pull arms, cable or other conventional means.

While the present invention has been described in connection with what are presently considered to be the most practical and preferred embodiments, it is to be understood that the invention is not to be limited to the disclosed embodiments, but to the contrary, is intended to cover various modifications and equivalent arrangements included within the spirit of the invention, which are set forth in the appended claims, and which scope is to be accorded the broadest interpretation so as to encompass all such modifications and equivalent structures.

1. A latch assembly comprising:
an axle rotatably disposed in a housing;
a handle affixed to said axle to rotate the axle upon operation of the handle;
an actuator bar, including a roller bearing, affixed to said axle responsive to rotation of said axle to translocate said actuator bar;
a pivot affixed to said housing;
an actuator plate rotatingly mounted to said pivot;
said roller bearing in rolling contact with said actuator plate to rotate said actuator plate in response to translocation of said actuator bar;
a connector element rotatingly mounted to said actuator plate repositioned from a first position to a second position upon rotation of said actuator plate in response to operation of said handle.

2. A latch assembly comprising:
a body, including a cavity in communication with two spaced apart essentially parallel channels which open onto a first surface of said body to form a first latch bolt channel and a second latch bolt channel;
a channel formed in said body extending from said cavity and opening onto a second surface of said body;
a first spring loaded latch bolt having an elongated slot disposed in the first latch bolt channel;
a second spring loaded latch bolt having an elongated slot disposed in the second latch bolt channel;
an operator shaft, including an engaging pin having a first end and a second end, disposed in said cavity and said channel opening onto said second surface;
said first end of said engaging pin positioned within the elongated slot of the first latch bolt;
said second end of said engaging pin positioned within the elongated slot of the second latch bolt;
said engaging pin operative to retain said first and second latch bolts within the first and second latch bolt channels, respectively, with a predetermined portion of said first and second latch bolts extending beyond said first surface of the body;
said operator shaft adapted to reciprocal motion within said cavity and said channel opening onto said second surface responsive to retract said latch bolts into said body upon repositioning of said operator shaft from a first position to a second position.

3. A latch assembly comprising:
an axle rotatably disposed in a housing;
a handle affixed to said axle to rotate the axle upon operation of the handle;
an actuator bar, including a roller bearing, affixed to said axle responsive to rotation of said axle to translocate said actuator bar;
a pivot affixed to said housing;
an actuator plate rotatingly mounted to said pivot;
said roller bearing in rolling contact with said actuator plate to rotate said actuator plate in response to translocation of said actuator bar;
a connector element rotatingly mounted to said actuator plate repositioned from a first position to a second position upon rotation of said actuator plate;
a body, including a cavity in communication with two spaced apart essentially parallel channels which open onto a first surface of said body to form a first latch bolt channel and a second latch bolt channel;
a channel formed in said body extending from said cavity and opening onto a second surface of said body;
a first spring loaded latch bolt having an elongated slot disposed in the first latch bolt channel;
a second spring loaded latch bolt having an elongated slot disposed in the second latch bolt channel;
an operator shaft, including an engaging pin having a first end and a second end, disposed in said cavity and said channel opening onto said second surface;
said first end of said engaging pin positioned within the elongated slot of the first latch bolt;
said second end of said engaging pin positioned within the elongated slot of the second latch bolt;
said engaging pin operative to retain said first and second latch bolts within the first and second latch bolt channels, respectively, with a predetermined portion of said first and second latch bolts extending beyond said first surface of the body;
said operator shaft rotatingly mounted to said connector element;
said operator shaft adapted to reciprocal motion within said cavity and channel opening onto said second surface responsive to retract said latch bolts into said body upon repositioning of said operator shaft from a first position to a second position in response to operation of said handle.

4. The latch assembly of claim 1 or claim 3 further including:
a connecting element rotatably mounted to said second distal portion.

5. The latch assembly of claim 1 or claim 3 further including:
a cam positionable to interferingly contact said actuator plate to prevent rotation of said actuator plate.

6. A latch assembly comprising:
a body having a first surface and a second surface and a cavity formed within;
a first channel extending from said cavity to the first surface of said body;
a first bolt, having a slot, slidingly disposed in said first channel;
a second channel extending from said cavity to the first surface of said body;
a second bolt, having a slot, slidingly disposed in said second channel;
a third channel extending from said cavity to the second surface of said body;
an operator shaft, including an engaging pin, slidingly disposed in said third channel;
said engaging pin disposed to engage said slots and retain said bolts in said body;
said first bolt adapted to slide within said first channel in response to motion of said operator shaft along said third channel; and
said second bolt adapted to slide within said second channel in response to motion of said operator shaft along said third channel.

7. The latch assembly of claim 6 wherein:
said first channel and said second channel are spaced apart and essentially parallel.

8. The latch assembly of claim 6 wherein:
said first channel, said second channel and said third channel are spaced apart and essentially parallel.

9. A latch assembly comprising:
a housing including a front side having a front surface and a back side having a rear surface;
a cavity having a cavity floor and cavity walls surrounding said cavity floor formed in said front side;
said cavity walls joining said front surface;
an axle rotatingly disposed in said cavity and penetrating at least one cavity wall;
a handle fixedly mounted to said axle to rotate said axle upon operation of said handle;
a lock mechanism mounted upon and penetrating said front surface;
a protrusion formed on said rear surface;
a mounting stud affixed to said protrusion;
an actuator plate including first, second and third distal portions rotatingly disposed and retained on said mounting stud;
a connecting element rotatably mounted to said first distal portion;
said first distal portion or said second distal portion including a first edge;
said lock mechanism extending to said rear side of the housing and having a rotatable cylinder including a locking cam which may be disposed in a first position and a second position in response to rotation of said lock mechanism whereby in said first position said locking cam is disposed to contact said third distal portion of the actuator plate to prevent rotation of the actuator plate and in said second position said locking cam is disposed to allow rotation of said actuator plate;
an actuator bar disposed adjacent said rear surface affixed to said axle to translocate said actuator bar upon operation of said handle;
a roller bearing rotatingly mounted on said actuator bar disposed in rolling contact with said first edge of said first or second distal portion to rotate said actuator plate from a first position to a second position upon translocation of the actuator bar in response to operation of said handle to reposition said connecting element from a first position to a second position;
a hollow body, having a first surface and an opposite second surface, said body including a cavity in communication with two spaced apart essentially parallel channels which each open onto said first surface of said body to form a first latch bolt channel and a second latch bolt channel;
a central channel parallel with said latch bolt channels formed in said body extending from said cavity and opening onto said second surface of said body;
a first spring loaded latch bolt having an elongated slot and a second spring loaded latch bolt having an elongated slot, disposed in the first and second latch bolt channels, respectively;
an operator shaft including an engaging pin having a first end and a second end disposed in said central channel and said cavity with said first end of the engaging pin positioned within the elongated slot of the first latch bolt and said second end of the engaging pin positioned within the elongated slot of the second latch bolt to retain said first and second latch bolts within the first and second latch bolt channels, respectively, with a predetermined portion of said first and second latch bolts extending beyond said first surface of the hollow body;
said operator shaft adapted to reciprocal motion within said central channel and cavity attached to said connecting element responsive to retract said latch bolts into said hollow body upon repositioning of said connecting element from a first position to a second position.

10. A latch assembly comprising:
a housing including a front side having a front surface and a back side having a rear surface;
a cavity having a cavity floor and cavity walls surrounding said cavity floor formed in said front side;
said cavity walls joining said front surface;
an axle rotatingly disposed in said cavity and penetrating at least one cavity wall;
a handle fixedly mounted to said axle to rotate said axle upon operation of said handle;
a lock mechanism mounted upon and penetrating said front surface;
a protrusion formed on said rear surface;
a mounting stud affixed to said protrusion;
an actuator plate including first, second and third distal portions rotatingly disposed and retained on said mounting stud;
a connecting element rotatably mounted to said first distal portion;
said first distal portion or said second distal portion including a first edge;
said lock mechanism extending to said rear side of the housing and having a rotatable cylinder including a locking cam which may be disposed in a first position and a second position in response to rotation of said lock mechanism whereby in said first position said locking cam is disposed to contact said third distal portion of the actuator plate to prevent rotation of the actuator plate and in said second position said locking cam is disposed to allow rotation of said actuator plate;
an actuator bar disposed adjacent said rear surface affixed to said axle to translocate said actuator bar upon operation of said handle;
a roller bearing rotatingly mounted on said actuator bar disposed in rolling contact with said first edge of said first or second distal portion to rotate said actuator plate from a first position to a second position upon translocation of the actuator bar in response to operation of said handle to reposition said connecting element from a first position to a second position.

11. The latch assembly of claim 9 or claim 10 further including:
a connecting element rotatably mounted to said second distal portion.

12. A latch assembly comprising:
a hollow body, having a first surface and an opposite second surface, said body including a cavity in communication with two spaced apart essentially parallel channels which each open onto said first surface of said body to form a first latch bolt channel and a second latch bolt channel;
a central channel parallel with said latch bolt channels formed in said body extending from said cavity and opening onto said second surface of said body;
a first spring loaded latch bolt having an elongated slot and a second spring loaded latch bolt having an elongated slot, disposed in the first and second latch bolt channels, respectively;
an operator shaft, including an engaging pin having a first end and a second end, disposed in said central channel and said cavity with said first end of the engaging pin positioned within the elongated slot of the first latch bolt and said second end of the engaging pin positioned within the elongated slot of the second latch bolt to retain said first and second latch bolts within the first and second latch bolt channels, respectively, with a predetermined portion of said first and second latch bolts extending beyond said first surface of the hollow body;
said operator shaft adapted to reciprocal motion within said central channel and cavity responsive to retract said latch bolts into said hollow body upon repositioning of said operator shaft from a first position to a second position.
